(19) United States
(12) Patent Application Publication
(10) Pub. No.: US 2006/0212348 A1
(43) Pub. Date: Sep. 21, 2006

(54) Method for scheduling of broadcast events

(76) Inventors: Matthew Cody Lambert, Knoxville, TN (US); Kevin Travis Woods, Knoxville, TN (US)

Correspondence Address: NEXSEN PRUETT JACOBS & POLLARD, 201 W MCBEE AVENUE, SUITE 400, GREENVILLE, SC, 29601, US

(21) Appl. No.: 11/193,518

(22) Filed: Jul. 29, 2005

Related U.S. Application Data
(60) Provisional application No. 60/671,706, filed on Apr. 15, 2005.
(60) Provisional application No. 60/661,706, filed on Mar. 15, 2005.

(51) Int. Cl. G06Q 30/00

(52) U.S. Cl. 705/14

(57) ABSTRACT

A system and method for scheduling advertisements. The system has an inventory of advertisements wherein each advertisement comprises a demographic and a client identifier. An interface is provided for receiving an order wherein the order has a target demographic, a target client identifier, impressions to be played (I), value (V), time remaining (T) and a product code (PC). An order priority is determined wherein for each advertisement of the advertisements the demographic matches the target demographic and the client identifier matches the target client identifier and the advertisements are sorted by priority (P) into a priority list. The priority for each advertisement is a function of the impressions to be played, the value, and the time remaining. An order queue is provided wherein the priority list is resorted by an attractiveness into a play list. The attractiveness (A) is a function of the priority, a number of spot blocks played since the advertisement last played (L) and a number of spot blocks since an advertisement with the same product code last played (S). An ad picker is provided which is capable of receiving a request for a spot block from an ad enabled playlist and providing a sufficient number of advertisements from the play list in order of attractiveness to fill the spot block and transmit the advertisements to the ad enabled playlist and wherein the ad picker monitors when a player plays each advertisement and determines the number of spot blocks played since the advertisement last played (L) and the number of spot blocks since an advertisement with the same product code last played (S). A player receives and plays the spot block.

### CROSS-REFERENCE TO RELATED APPLICATIONS

The present application claims priority to pending U.S. Provisional Appl. No. 60/671,706 filed Apr. 15, 2005.

### BACKGROUND OF THE INVENTION

The present invention is related to an improved method for scheduling broadcast events. More particularly, the present invention is related to an improved method for scheduling advertisements.

Broadcast media relies on advertisements for revenue. Scheduling the advertising has been a long standing problem with many approaches being used to insure that advertisements are scheduled for the correct time slot and order.

The broadcaster typically guarantees to the advertiser that each commercial will be played for a certain number of times within a given time frame. As would be understood the advertiser does not wish to have the advertisement air a large number of times in the beginning of the time frame at the expense of airing in the latter part of the time frame. Likewise, the broadcaster does not wish to delay advertisement since this may cause a large number of advertisements remaining to be aired at the end of the time frame which is undesirable. The broadcaster also has financial constraints to consider. For example, an advertisement which generates more revenue per airing should have priority over those that generate less revenue. In the past, the revenue generation aspects have been largely avoided since this placed an undo burden on the scheduler.

As realized from the foregoing, the task of scheduling advertisements has largely been done by human. There has been a desire to automate such a task but the success is limited due to the lack of a suitable method upon which an automated system can be based.

The present invention solves a long standing problem related to advertisment scheduling and lends itself to computerized scheduling thereby greatly increasing the efficiency of scheduling advertising.

### SUMMARY OF THE INVENTION

It is an object of the present invention to provide a method and system for determining play order of advertisements.

It is an object of the present invention to provide a method and system for determining a play list based on a priority system which takes into consideration the value of the advertisement, the time remaining to be broadcast and the number of impressions remaining to be played.

It is yet another object of the present invention to provide a method and system for determining a play list based on an attractiveness which takes into consideration priority, number of spot blocks played since the advertisement was last played and the number of spot blocks since an advertisement with the same product code was played.

A particular feature of the present invention is the ability to optimize the play selection by the use of advertiser selectable weighting factors.

These and other advantages, as will be realized, are provided in a system for scheduling advertisements. The system has an inventory of advertisements wherein each advertisement comprises a demographic and a client identifier. An interface is provided for receiving an order wherein the order has a target demographic, a target client identifier, impressions to be played (I), value (V), time remaining (T) and a product code (PC). An order priority is determined wherein for each advertisement of the advertisements the demographic matches the target demographic and the client identifier matches the target client identifier and the advertisements are sorted by priority (P) into a priority list. The priority for each advertisement is a function of the impressions to be played, the value, and the time remaining. An order queue is provided wherein the priority list is resorted by an attractiveness into a play list. The attractiveness (A) is a function of the priority, a number of spot blocks played since the advertisement last played (L) and a number of spot blocks since an advertisement with the same product code last played (S). An ad picker is provided which is capable of receiving a request for a spot block from an ad enabled playlist and providing a sufficient number of advertisements from the play list in order of attractiveness to fill the spot block and transmit the advertisements to the ad enabled playlist and wherein the ad picker monitors when a player plays each advertisement and determines the number of spot blocks played since the advertisement last played (L) and the number of spot blocks since an advertisement with the same product code last played (S). A player receives and plays the spot block.

Yet another embodiment is provided in a system for scheduling advertisements. The system has an inventory of advertisements wherein each advertisement comprises a demographic and a client identifier. An interface receives an order with a target demographic, target client identifier, impressions to be played (I); value (V); time remaining (T); a product code (PC); a weighting factor for impressions remaining (I_{w}); a weighting factor for value (V_{w}); and a weighting factor for time remaining (T_{w}); a weighting factor for priority (P_{w}); a weighting factor for the number of spot blocks played since each advertisement was last played (L_{w}); and a weighting factor for the number of spot blocks played since an advertisement with the same product code played (S_{w}). An order priority is determined wherein each advertisement of the advertisements matches the target advertisement, each demographic matches the target demographic and the client identifier matches the target client identifier. The advertisements in the order priority are sorted by priority (P) into a priority list wherein the priority is calculated as:
P=(I_{w}*I/Iₘₐₓ+V_{w}*V/Vₘₐₓ+Tw*(Tₘₐₓ−T)/Tₘₐₓ)/3.
wherein Iₘₐₓ is the maximum value of I for all advertisement; Tₘₐₓ is the maximum value of T for all advertisement; and Vₘₐₓ is the maximum V for all advertisements. An order queue is provided wherein the priority list is resorted by an attractiveness into a play list wherein the attractiveness (A) is a function of the priority, a number of spot blocks played since the advertisement last played (L) and a number of spot blocks since an advertisement with the same product code last played (S). A is calculated as:
A=(P*P_{w}+(L/Lₘₐₓ)*L_{w}+(S/Sₘₐₓ)*S_{w})/3
wherein Lₘₐₓ is the maximum value of L for all advertisement; and Sₘₐₓ is the maximum number of spot blocks played since an advertisement with the same product code played for all advertisements. An ad picker is provided which is capable of receiving a request for a spot block from an ad enabled playlist and providing a sufficient number of advertisements from play list in order of attractiveness to fill the spot block and transmit the advertisements to the ad enabled playlist. The picker monitors when a player plays each advertisement and determines the number of spot blocks played since the advertisement last played (L) and the number of spot blocks since an advertisement with the same said product code last played (S). A player receives and plays the spot block.

Yet another embodiment is provided in a method for determining a play order of advertisements including:
a) receiving orders wherein each order of the orders comprises a target client identifier, a target demographic, a value (V) , a time remaining (T) and impressions remaining (I);
b) extracting a first list of advertisements from an inventory wherein each advertisement of the first list of advertisements has a client identification which is the same as the target client identifier and a demographic which is the same as the target demographic;
c) sorting the first list of advertisements by order of decreasing priority (P) wherein the priority is a function of the value, the time remaining and the impressions remaining to form a priority list;
d) receiving a spot block from a player indicating a number of advertisements, which correlates to run time of the advertisements, required to fill the spot block;
e) providing advertisements in order of decreasing priority from the priority list sufficient to fill the spot block;
f) playing the spot block;
g) determining a number of spot blocks played since the advertisement last played (L) and a number of spot blocks since an advertisement with the same product code last played (S);
h) resorting the advertisements by attractiveness (A) wherein the attractiveness is a function of priority, number of spot blocks played since the advertisement last played (L) and number of spot blocks since an advertisement with the same product code last played (S) to form an attractiveness list;
i) receiving a second spot block from a player indicating a number of advertisements required to fill thesecond spot block;
j) providing advertisements in order of attractiveness from the attractiveness list sufficient to fill the second spot block; and
k) playing said second spot block.

Yet another embodiment is provided in a method for determining a play order of advertisements including:
a) receiving orders wherein each order of the orders has a target client identifier, a target demographic, a value (V); a time remaining (T); impressions remaining (I); a weighting factor for impressions remaining (I_{w}); a weighting factor for value (V_{w}); a weighting factor for time remaining (T_{w}); a weighting factor for priority (P_{w}); a weighting factor for the number of spot blocks played since each advertisement was last played (L_{w}); and a weighting factor for the number of spot blocks played since an advertisement with the same product code played (S_{w}).;
b) extracting a first list of advertisements from an inventory wherein each advertisement of the first list of advertisements has a client id list wherein each advertisment of the first list of advertisements has a client identifier which is the same as the target client identifier and a demographic which is the same as the target demographic;
c) sorting the advertisements by order of priority (P) wherein the priority is defined as
   P=(I_{w}*I/Iₘₐₓ+V_{w}*V/Vₘₐₓ+Tw*(Tₘₐₓ−T)/Tₘₐₓ)/3
   wherein Iₘₐₓ is the maximum value of I for all advertisement; Tₘₐₓ is the maximum value of T for all advertisement; and Sₘₐₓ is the maximum number of spot blocks played since an advertisement with the same product code played for all advertisements;
d) receiving a spot block from a player indicating a number of advertisements required to fill the spot block;
e) providing advertisements in order of priority sufficient to fill the spot block;
f) playing the spot block;
g) determining a number of spot blocks played since the advertisement last played (L) and a number of spot blocks since an advertisement with the same product code last played (S);
h) resorting the advertisements by attractiveness (A) wherein the attractiveness is defined as:
   A=(P*P_{w}+(L/Lₘₐₓ)*L_{w}+(S/Sₘₐₓ)*S_{w})/3
   wherein Lₘₐₓ is the maximum value of L for all advertisement; and Sₘₐₓ is the maximum number of spot blocks played since an advertisement with the same product code played for all advertisements;
i) receiving a second spot block from a player indicating a number of advertisements required to fill the second spot block;
j) providing advertisements in order of attractiveness sufficient to fill the second spot block; and
k) playing the second spot block.

### BRIEF DESCRIPTION OF THE FIGURES

FIG. 1 is a schematic representation of a system of the present invention.

FIG. 2 is a flow chart representation of the method of the present invention.

### DETAILED DESCRIPTION OF THE INVENTION

The present invention is directed to a method, and system, for scheduling advertisements over a broadcast network by taking the time increment, the number of impressions and the monetary value into consideration in a weighted manner to prepare a play list. The method and system further allows for incorporation of an attractiveness factor for further optimization of the playlist.

The invention will be described with reference to the various figures forming a part of the specification.

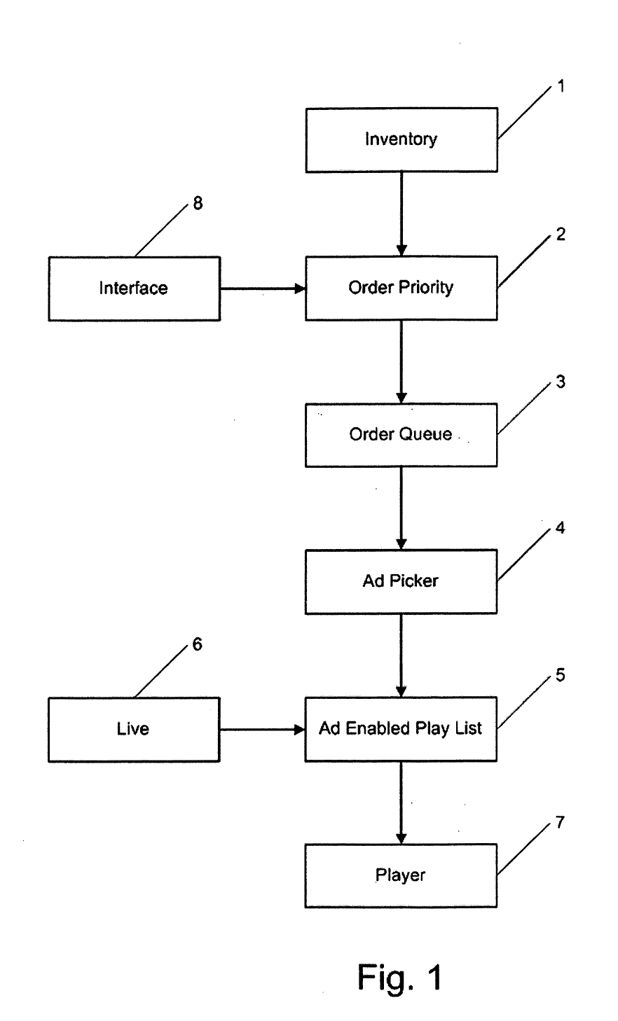

The system will be described with reference to FIG. 1. In FIG. 1, an inventory, 1, of advertisements comprises all advertisements available for play. Each advertisement has associated therewith a client identifier (CI) and a demographic (DG). The client identifier preferable comprises a product code (PC) particularly when multiple advertisements are inventoried for each client or multiple advertisements are inventoried for a particular product of a client. If a client only has one advertisement the client identifier and product code may be the same. Based on the demographic and client identifier a subset of the inventory is created as an order priority, 2, and sorted by priority as will be more fully described infra. The advertisements are then reordered by attractiveness as an order queue, 3, as will be more fully described infra. An ad picker, 4, retrieves the advertisements from the order queue at the request of an ad enabled playlist, 5, which switches between a live broadcast, 6, and the advertisements for transmission to the player, 7. The ad enabled play list has publication points for the live, or regular, broadcast and for the advertisements. The ad picker, 4, also maintains a record of the advertisements that have been played, the time of the playing and the audience size for each advertisement, for redetermination of order at the order queue as will be more fully appreciated from further description herein. An interface, 8, allows the input of the advertiser parameters such as the weighting factors, demographics, client identifier, product code, value, impressions, time preferably by start and end time, and the like.

Through communication between the ad picker and the order queue a dynamic playlist is provided comprising a spot block of advertisements specific to a demographic's attributes. The ad enabled playlist requests advertisements based on the spot block to be filled and a play list is transmitted from the ad picker to fill the spot block.

Supplementary information regarding the advertisement may be added if it has been supplied by the advertiser. This includes but is not limited to impressions, meta files, titles, and click through URL's. The supplementary information embedded in the playlist is detected by the end users player and appropriately displayed.

To ensure that no dead air is encountered when advertisements are not available, a predefined piece of media is preferably inserted at the end of the generated playlist. If no other advertisements are inserted into the playlist, or if the duration of the advertisements inserted is not sufficient to cover the duration of the entire spot block, this piece of media will be played. It is the intention that the predefined piece of media is rarely realized since this represents a miscalculation in the length of the spot or the total time of the advertisements.

The order priority comprising the advertisement, client indentifier, product code, demographics, priority and the length is a list of active orders for a specific demographic of a station sorted by priority. Each advertisement in the list is assigned a calculated priority value to determine the importance of the order. The priority, P, of the order is calculated by Formula I:
P=I+V+1/T Formula I
wherein:
T is the remaining time, preferably in seconds, calculated as the end time of order minus the current time;
I is the remaining impressions needed, preferably as an integer, calculated as the total number of impressions to be played minus the number of impressions already played; and
V is the monetary value of the order typically expresses as a monetary value per predetermined number of impressions. The priority may be normalized to be within a predetermined range, preferably as 0 to 1, if desired for later calculations.

It is often desirable to sort based on a normalize priority, Pⁿ, by application of Formula II:
Pⁿ=(I/Iₘₐₓ+V/Vₘₐₓ+(Tₘₐₓ−T*)/Tₘₐₓ)/3 Formula II
wherein:
Iₘₐₓ is the maximum I value for all orders;
Vₘₐₓ is the maximum V value for all orders; and
Tₘₐₓ is the maximum T value for all orders.

In one embodiment Tₘₐₓ may have an arbitrarily set limit, such as twenty four hours, so that any advertisement that has not played will have the maximum value for the time component of the formula. For example, with a twenty four hour limit, the priority will automatically increase at the end of the twenty four hour period thereby increasing the priority for the advertisement and increasing the likelihood that it will be played within the arbitrary set time limit.

The priority is highest when the remaining number of impressions is high, the value of the order is high and the remaining time for the order is low. The priority is lowest when the remaining number of impressions is low, the value of the order is low and the remaining time for the order is high.

In many circumstances the weighting of parameters may be modified to insure optimization to certain business criteria. In this instance a Weighted Priority, P^{w}, can be calculated by Formula III:
P^{w}=(I_{w}*I/Iₘₐₓ+V_{w}*V/Vₘₐₓ+Tw*(Tₘₐₓ−T)/Tₘₐₓ)/3 Formula III
wherein:
I_{w} is the weighting factor for impressions remaining;
V_{w} is the weighting factor for value; and
T_{w} is the weighting factor for time remaining wherein it is preferable that I_{w}+V_{w}+T_{w}=1.

A weighting scheme in accordance with Formula III allows for adjustments by the advertiser based on the particulars of the scheduler. For example, if the advertiser wishes for the value of the advertisements to affect the selection of advertisements more or less the value of V_{w} can be raised or lowered accordingly.

A particular feature of the present invention is the ability to further account for recent play of an same advertisement or an advertisement for the same or a related product. This secondary consideration is based on attractiveness and the advertisements are further sorted by attractiveness at the order queue.

The order queue comprises advertisement and associated parameters, spot block ID, and advertisements played. The order queue contains a pre-generated queue of spot blocks for a given demographic of a station. Pre-generation allows for quick fetching of spot blocks with minimum real-time calculation. The order queue also serves as a backlog of historical data for played advertisements until the data is aggregated. A spot block is a set of advertisements which play during a predefined commercial break. For example, a one minute spot block may comprise one thirty second advertisement and two fifteen second advertisements. Alternatively, a one minute spot block may contain four fifteen second advertisements.

The order queue is generated by calculating an attractiveness (A) based upon the priority of the order and the number of spot blocks that have played since the advertisement order played and when an advertisement with an identical product code last played. The attractiveness of an advertisement is calculated by Formula IV:
A=P+L+S Formula IV
wherein P is the priority, preferably normalized and/or weighted, of the advertisement as defined supra;
L is the number of spot blocks played since the advertisement was last played; and
S is the number of spot blocks played since an advertisement with the same product code (PC) played.

It is preferable to normalize the attractiveness by Formula V:
Aⁿ=P+(L/Lₘₐₓ)+(S/Sₘₐₓ) Formula V
wherein Lₘₐₓ is the maximum value of L for all orders; and
Sₘₐₓ is the maximum number of spot blocks played since an advertisement with the same product code played for all orders.

Attractiveness can be divided by 3 to further normalize between 0 and 1.

Attractiveness is higher when the priority of the advertisement is high, when many spot blocks have played since the advertisement last played or when many spot blocks have played since a similar product's advertisement last played. Attractiveness is lower when the priority of the advertisement is low, when few spot blocks have played since the advertisement last played or when few spot blocks have played since a similar products advertisement last played.

The attractiveness can be optimized by weighting factors provided by the Advertiser as set forth in Formula VI:
A^{w}=(P*P_{w}+(L/Lₘₐₓ)*L_{w}+(S/Sₘₐₓ)*S_{w})/3 Formula VI
wherein P_{w} is the weighting factor for priority;
L_{w} is the weighting factor for the number of spot blocks played since the advertisement was last played; and
S_{w} is the weighting factor for the number of spot blocks played since an advertisement with the same product code played wherein P_{w}+L_{w}+S_{w}=1.

The weighting factors allow for adjustments that affect the behavior of how often an advertisement will be played. The weighting factors can be adjusted to provide a sufficient balance between playing high priority advertisements often and not playing the same, or similar product's, advertisements too close together.

The attractiveness function allows for creation of a short term queue that will provide proper separation of advertisement plays. The spot blocks in the queue are created using a best fit algorithm to maximize the attractiveness of a group of advertisements that fit into the specified duration.

After each spot block the priority and attractiveness changes since the parameters used to calculate the priority and attractiveness differ due to the elapsed time and advertisements played. It is most preferred to recalculate attractiveness after each spot block and priority and after a series of spot blocks. Recalculating priorities periodically allows the advertisement inventory to be changed based on specified order time and date restrictions. For example certain advertisements may only be ordered to play between specified times or during specified days. In another example, after enough spot blocks have been played to complete one hour of broadcast time, or one show, the priority may be recalculated.

A scheduling configuration interface allows input of the modifier variables, also referred to as weighting factors, for priority and attractiveness. It is preferred that the modifier variables are all initially equal. The advertiser can then increase, or decrease, certain modifier variables with the other two of the set being automatically adjusted such that the normalized variables sum to 1. For example, the advertiser may be given a scale of 1-10 to adjust a certain modifier variables. As a modifer variable is adjusted the other two are recalculated automatically in response. Alternatively, the advertiser may be allowed to adjust all three modifier variables of a set with the normalization accomplished after selection.

A player receives the supplemental information embedded inside the dynamically generated playlist and dynamically displays this information to the end user.

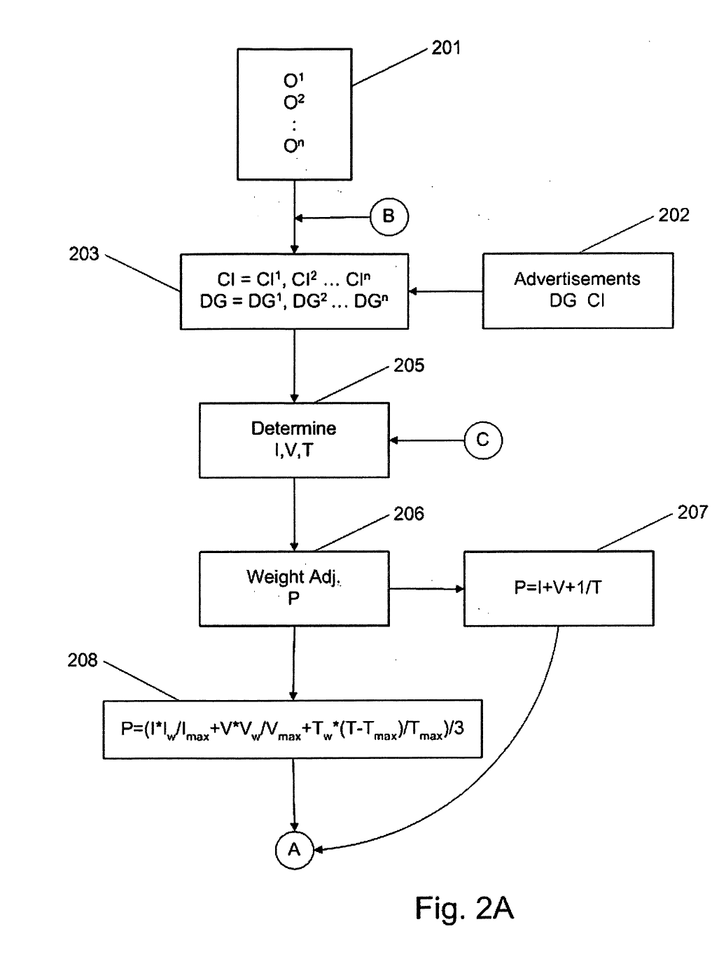

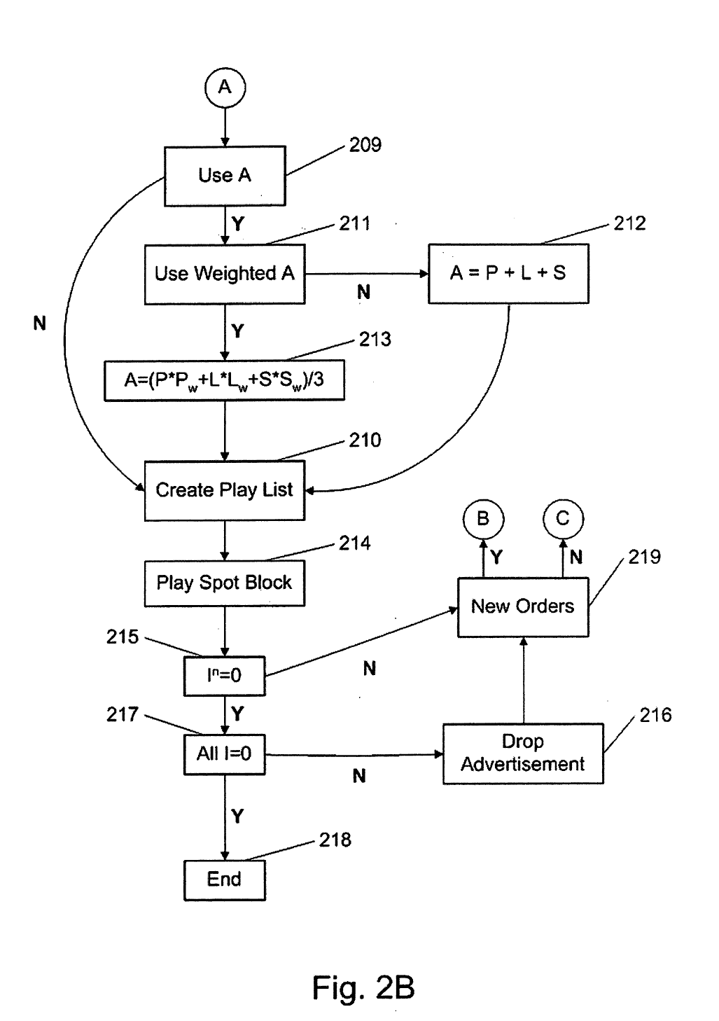

A representative flow chart is illustrated in FIG. 2. In FIG. 2 each order (O) is submitted at 201. The order (0) comprises I, V. T, I_{w}, V_{w}, T_{w}, P_{w}, L_{w}, S_{w}, DG and CI for each order indicated by superscript wherein I_{w}, V_{w}, T_{w}, P_{w}, L_{w} and S_{w} are defined supra, DG is the demographic information for the order and CI is the client identifier and may include a product code (PC) indicating related products or products covered by multiple advertisements. The advertisements are provided at, 202, wherein each advertisement has associated therewith a client identifier, CI, and demographic information, DG. Those advertisements wherein the client identifier and demographic information are the same as those submitted with the order are extracted and included in an initial play list at 203. At 205, the values of I, V and T remain the same as those initially set prior to any play and subsequent action will be described infra. A determination of the desire to use a weighted priority is made at 206. If no weighting adjustment is requested the priority is calculated at 207. If a weighted priority is desired the priority is calculated at 208. A determination of the desire to utilize attractiveness is made at 209. If attractiveness is not to be used to determine the play list is created at 210 based on priority. If attractiveness is to be used to determine the play list then a determination is made at 211 regarding the desire to use a weighted attractiveness. If a weighted attractiveness is not to be used then the attractiveness is calculated at 212 and the playlist is calculated at 210 using the attractiveness. If a weighted attractiveness is to be used then the attractiveness is calculated at 213 followed by creation of the order priority at 210. The advertisements are played at 214. At 215 a determination is made regarding the completion of any advertisement indicated by I being equal to zero. If any advertisement has completed the contracted number of plays a determination is made regarding the remaining advertisements at 217. If all advertisements are complete the program ends at 218. Otherwise, the complete advertisements are excluded from the list at 216 and the entry of new orders is determined at 219. If any advertisements have additional plays remaining a determination of the entry of new orders is made at 219. If no new orders are indicated at 219 the attractiveness is redetermined at 209. If new orders are indicated the initial play list is regenerated at 203.

Exemplary Code

Exemplary code is provided in Table 1. The code is intended to illustrate without limiting the claimed invention. One of skill in the art could devise code suitable for demonstrating the invention as set forth herein.

```
TABLE 1
structure advertisement
{
    var Description;
    var Advertiser;
    var ProductCode;
    var MediaInformation;
    var Metadata;
    ...
}
structure order
{
    var StartDate;
    var EndDate;
    var Advertisement;
    var Value;
    var GoalImpressions;
    var CurrentImpressions;
    var Target Client;
    var TargetDemographic;
    ...
}
    /* START PRE-DEFINED VARIABLES */
```

| | |
|---|---|
| var Orders; | // an array of all orders |
| var Target Client; | // Target station for this queue |
| var TargetDemographic; | // Demographic information |
| | for this queue |
| | // Priority Weights: |
| var Iweight; | // The weighting factor for impressions |
| | remaining |
| var Vweight; | // The weighting factor for value |
| var Tweight; | // The weighting factor for time |
| | // Attractiveness Weights: |
| var Lweight; | // The weighting factor for the number |
| | // of spot blocks that have occured |
| | // since the order last played |
| var Sweight; | // The weighting factor for the |
| | // number of spot blocks that have |
| occured since an identical | |
| | // product code has played |
| var Pweight; | // The weighting factor for the priority |

/* END PRE-DEFINED VARIABLES */

| | |
|---|---|
| var Vmax; | // The highest V (Value) for all orders |
| var Tmax; | // The highest T (Remaining Time) |
| | for all orders |
| var Imax; | // The highest I (Remaining |
| | // Impressions) for all orders |
| var Lmax; | // The highest L (Spot blocks that have |
| | // occured since the order played) |
| | for all orders |
| var Smax; | // The highest S (Spot blocks that have |
| | // occured since an identical |
| product code has played) | |
| | // for all orders |

```
/* Prioritize active orders */
FOR EACH order O in Orders that matches the Target Client and
TargetDemographic
{
    var I = O->GoalImpressions − O->CurrentImpressions;
    var T = O->EndDate − NOW;
    var V = O->Value;
    var P = I * IWeight / Imax;
    P = P + V * Vweight / Vmax;
    P = P + (Tmax − T) * Tweight / Tmax
```

| | |
|---|---|
| P = P / 3; | // Normalize P |

```
    L = Number of spot blocks since O played
    S = Number of spot blocks since a product O->ProductCode played
    var A = P * Pweight;
    A = A + L * Lweight /Lmax
    A = A + S * Sweight /Smax
```

| | |
|---|---|
| PriorityQueue[O] = A | // Add the order and it's attractiveness |
| | // to the priority queue |

}
/* Build Spot Block from PriorityQueue */
WHILE spot block is not full
{
Add order with highest priority from PriorityQueue to spot block
}

The invention has been described with particular emphasis on the preferred embodiments without limit thereto. One of skill in the art would realize additional embodiments without departing from the scope of the invention with is set forth in the claims appended hereto.

1. A system for scheduling advertisements comprising:
an inventory of advertisements wherein each advertisement comprises a demographic and a client identifier;
an interface for receiving an order comprising: a target demographic, a target client identifier, impressions to be played (I), value (V), time remaining (T) and a product code (PC);
an order priority wherein each advertisement of said advertisements wherein said demographic matches said target demographic and said client identifier matches said target client identifier is sorted by priority (P) into a priority list wherein said priority for each advertisement is a function of said impressions to be played, said value, and said time remaining;
an order queue wherein said priority list is resorted by an attractiveness into a play list wherein said attractiveness (A) is a function of said priority, a number of spot blocks played since said advertisement last played (L) and a number of spot blocks since an advertisement with the same said product code last played (S);
an ad picker capable of receiving a request for a spot block from an ad enabled playlist and providing a sufficient number of advertisements from said play list in order of attractiveness to fill said spot block and transmit said advertisements to said ad enabled playlist and wherein said ad picker monitors when a player plays each advertisement and determines said number of spot blocks played since said advertisement last played (L) and said number of spot blocks since an advertisement with the same said product code last played (S); and said player receives and plays said spot block.

2. The system of claim 1 wherein said priority is determined by the equation:
P=I+V+1/T

3. The system of claim 1 wherein said priority is determined by the equation:
P=(I/Iₘₐₓ+V/Vₘₐₓ+(Tmax−T)/Tₘₐₓ)/3
wherein:
Iₘₐₓ is the maximum I value for all orders;
Vₘₐₓ is the maximum V value for all orders; and
Tₘₐₓ is the maximum T value for all orders.

4. The system of claim 1 wherein said interface comprises: a weighting factor for impressions remaining (I_{w}); a weighting factor for value (V_{w}); and a weighting factor for time remaining (T_{w}).

5. The system of claim 4 wherein said priority is determined by the equation:
P=(I_{w}*I/Iₘₐₓ+V_{w}*V/Vₘₐₓ+Tw*(Tₘₐₓ−T)/Tₘₐₓ)/3
wherein:
Iₘₐₓ is the maximum I value for all orders;
Vₘₐₓ is the maximum V value for all orders; and
Tₘₐₓ is the maximum T value for all orders.

6. The system of claim 5 wherein I_{w}+V_{w}+T_{w}=1.

7. The system of claim 1 wherein said attractiveness is determined by the equation:
A=P+L+S.

8. The system of claim 1 wherein said attractiveness is determined by the equation:
A=P+(L/Lₘₐₓ)+(S/Sₘₐₓ)
wherein Lₘₐₓ is the maximum value of L for all orders; and
Sₘₐₓ is the maximum number of spot blocks played since an advertisement with the same product code played for all orders.

9. The system of claim 1 wherein said interface further receives: a weighting factor for priority (P_{w}); a weighting factor for the number of spot blocks played since each advertisement was last played (L_{w}); and a weighting factor for the number of spot blocks played since an advertisement with the same product code played (S_{w}).

10. The system of claim 9 wherein said attractiveness is determined by the equation:
A=(P*P_{w}+(L/Lₘₐₓ)*L_{w}+(S/Sₘₐₓ)*S_{w})/3
wherein:
Lₘₐₓ is the maximum value of L for all orders; and
Sₘₐₓ is the maximum number of spot blocks played since an advertisement with the same product code played for all orders.

11. The system of claim 10 wherein P_{w}+L_{w}+S_{w}=1.

12. A system for scheduling advertisements comprising:
an inventory of advertisements wherein each advertisement comprises a demographic and a client identifier;
an interface comprising, target demographic, target client identifier, impressions to be played (I); value (V); time remaining (T); a product code (PC); a weighting factor for impressions remaining (I_{w}); a weighting factor for value (V_{w}); and a weighting factor for time remaining (T_{w}); a weighting factor for priority (P_{w}); a weighting factor for the number of spot blocks played since each advertisement was last played (L_{w}); and a weighting factor for the number of spot blocks played since an advertisement with the same product code played (S_{w});
an order priority wherein for each advertisement of said advertisements said demographic matches said target demographic and said client identifier matches said target client identifier is sorted by priority (P) into a priority list wherein said priority is calculated as:
P=(I_{w}*I/Iₘₐₓ+V_{w}*V/Vₘₐₓ+Tw*(Tₘₐₓ−T)/Tₘₐₓ)/3.
wherein wherein Iₘₐₓ is the maximum value of I for all advertisement; Tₘₐₓ is the maximum value of T for all advertisement; and Vₘₐₓ is the maximum V for all advertisements;
an order queue wherein said priority list is resorted by an attractiveness into a play list wherein said attractiveness (A) is a function of said priority, a number of spot blocks played since said advertisement last played (L) and a number of spot blocks since an advertisement with the same said product code last played (S) and A is calculated as:
A=(P*P_{w}+(L/Lₘₐₓ)*L_{w}+(S/Sₘₐₓ)*S_{w})/3
wherein Lₘₐₓ is the maximum value of L for all advertisement; and Sₘₐₓ is the maximum number of spot blocks played since an advertisement with the same product code played for all advertisements;
an ad picker capable of receiving a request for a spot block from an ad enabled playlist and providing a sufficient number of advertisements from said play list in order of attractiveness to fill said spot block and transmit said advertisements to said ad enabled playlist and wherein said picker monitors when a player plays each advertisement and determines said number of spot blocks played since said advertisement last played (L) and said number of spot blocks since an advertisement with the same said product code last played (S); and
said player receives and plays said spot block.

13. A method for determining a play order of advertisements comprising:
receiving orders wherein each order of said orders comprises a target client identifier, a target demographic, a value (V), a time remaining (T) and impressions remaining (I);
extracting a first list of advertisements from an inventory wherein each advertisement of said first list of advertisements has a client identification which is the same as said target client identifier and a demographic which is the same as said target demographic;
sorting said first list of advertisements by order of decreasing priority (P) wherein said priority is a function of said value, said time remaining and said impressions remaining to form a priority list;
receiving a spot block from a player indicating a number of advertisements required to fill said spot block;
providing advertisements in order of decreasing priority from said priority list sufficient to fill said spot block;
playing said spot block;
determining a number of spot blocks played since said advertisement last played (L) and a number of spot blocks since an advertisement with the same said product code last played (S);
resorting said advertisements by attractiveness (A) wherein said attractiveness is a function of said priority, said number of spot blocks played since said advertisement last played (L) and said number of spot blocks since an advertisement with the same said product code last played (S) to form an attractiveness list;
receiving a second spot block from a player indicating a number of advertisements required to fill said second spot block;
providing advertisements in order of attractiveness from said attractiveness list sufficient to fill said second spot block;
playing said second spot block.

14. The method for determining a play order of advertisements of claim 13 wherein said priority is determined by the equation:
P=I+V+1/T.

15. The method for determining a play order of advertisements of 13 wherein said priority is determined by the equation:
P=(I/Iₘₐₓ+V/Vₘₐₓ+(Tₘₐₓ−T)/Tₘₐₓ)/3
wherein:
Iₘₐₓ is the maximum I value for all orders;
Vₘₐₓ is the maximum V value for all orders; and
Tₘₐₓ is the maximum T value for all orders.

16. The method for determining a play order of advertisements of claim 13 wherein said receiving orders further comprises receiving a weighting factor for impressions remaining (I_{w}); a weighting factor for value (V_{w}); and a weighting factor for time remaining (T_{w}).

17. The method for determining a play order of advertisements of claim 16 wherein said priority is determined by the equation:
P=(I_{w}*I/Iₘₐₓ+V_{w}*V/Vₘₐₓ+Tw*(Tₘₐₓ−T)/Tₘₐₓ)/3
wherein Iₘₐₓ is the maximum value of I for all advertisement; Tₘₐₓ is the maximum value of T for all advertisement; and Vₘₐₓ is the maximum V for all advertisements.

18. The method for determining a play order of advertisements of claim 17 wherein:
I_{w}+V_{w}+T_{w}=1.

19. The method for determining a play order of advertisements of claim 13 wherein said attractiveness is determined by the equation:
A=P+L+S.

20. The method for determining a play order of advertisements of claim 13 wherein said attractiveness is determined by the equation:
A=P+(L/Lₘₐₓ)+(S/Sₘₐₓ)
wherein Lₘₐₓ is the maximum value of L for all orders; and
Sₘₐₓ is the maximum number of spot blocks played since an advertisement with the same product code played for all orders.

21. The method for determining a play order of advertisements of claim 13 wherein said receiving orders further comprises receiving a weighting factor for priority (P_{w}); a weighting factor for the number of spot blocks played since each advertisement was last played (L_{w}); and a weighting factor for the number of spot blocks played since an advertisement with the same product code played (S_{w}).

22. The method for determining a play order of advertisements of claim 21 wherein said attractiveness is determined by the equation:
A=(P*P_{w}+(L/Lₘₐₓ)*L_{w}+(S/Sₘₐₓ)*S_{w})/3
wherein Lₘₐₓ is the maximum value of L for all advertisement; and Sₘₐₓ is the maximum number of spot blocks played since an advertisement with the same product code played for all advertisements.

23. The method for determining a play order of advertisements of claim 22 wherein:
P_{w}+L_{w}+S_{w}=1.

24. A method for determining a play order of advertisements comprising:
receiving orders wherein each order of said orders comprises a target client identifier, a target demographic, a value (V); a time remaining (T); impressions remaining (I); a weighting factor for impressions remaining (I_{w}); a weighting factor for value (V_{w}); a weighting factor for time remaining (T_{w}); a weighting factor for priority (P_{w}); a weighting factor for the number of spot blocks played since each advertisement was last played (L_{w}); and a weighting factor for the number of spot blocks played since an advertisement with the same product code played (S_{w});
extracting a first list of advertisements from an inventory wherein each advertisement of said first list of advertisements has a client id list wherein each advertisment of said first list of advertisements has a client identifier which is the same as said target client identifier and a demographic which is the same as said target demographic;
sorting said advertisements by order of priority (P) wherein said priority is defined as
P=(I_{w}*I/Iₘₐₓ+V_{w}*V/Vₘₐₓ+Tw*(Tₘₐₓ−T)/Tₘₐₓ)/3
wherein Iₘₐₓ is the maximum value of I for all advertisement; Tₘₐₓ is the maximum value of T for all advertisements; and Sₘₐₓ is the maximum number of spot blocks played since an advertisement with the same product code played for all advertisements;
receiving a spot block from a player indicating a number of advertisements required to fill said spot block;
providing advertisements in order of priority sufficient to fill said spot block;
playing said spot block;
determining a number of spot blocks played since said advertisement last played (L) and a number of spot blocks since an advertisement with the same said product code last played (S);
resorting said advertisements by attractiveness (A) wherein said attractiveness is defined as:
A=(P*P_{w}+(L/Lₘₐₓ)*L_{w}+(S/Sₘₐₓ)*S_{w})/3
wherein Lₘₐₓ is the maximum value of L for all advertisement; and Sₘₐₓ is the maximum number of spot blocks played since an advertisement with the same product code played for all advertisements;
receiving a second spot block from a player indicating a number of advertisements required to fill said second spot block;
providing advertisements in order of attractiveness sufficient to fill said second spot block; and
playing said second spot block.
